(19) United States
(12) Patent Application Publication
(10) Pub. No.: US 2025/0061353 A1
(43) Pub. Date: Feb. 20, 2025

(54) TIME-SERIES DATA FORECASTING VIA MULTI-MODAL AUGMENTATION AND FUSION

(71) Applicant: NEC Laboratories America, Inc., Princeton, NJ (US)

(72) Inventors: Wenchao Yu, Plainsboro, NJ (US); Wei Cheng, Princeton Junction, NJ (US); Haifeng Chen, West Windsor, NJ (US); Geon Lee, Monmouth Junction, NJ (US)

(21) Appl. No.: 18/806,025

(22) Filed: Aug. 15, 2024

Related U.S. Application Data
(60) Provisional application No. 63/533,391, filed on Aug. 18, 2023.
(60) Provisional application No. 63/539,909, filed on Sep. 22, 2023.

(51) Int. Cl. G06N 5/022; G06N 20/00

(52) U.S. Cl. CPC G06N 5/022; G06N 20/00

(57) ABSTRACT

Systems and methods for time-series forecasting via multi-modal augmentation and fusion. Time-series data and modality data can be decomposed into seasonal and trend representations with trend-seasonal decomposition. Using an encoder transformer model, time-series data embeddings and modality data embeddings can be concatenated from the seasonal representations and the trend representations to obtain crossed representations. Using the encoder transformer model, the modality data embeddings and the time-series data embeddings can be processed separately to obtain singular representations. The crossed representations and the singular representations can be augmented through joint trend-seasonal decomposition to obtain augmented seasonal data and augmented trend data. Using a decoder, augmented seasonal data and augmented trend data can be fused to obtain fused augmented data. Corrective action can be performed to correct predicted future events using a system with a prediction model trained with the fused augmented data.

### RELATED APPLICATION INFORMATION

This application claims priority to U.S. Provisional App. No. 63/533,391, filed on Aug. 18, 2023, and U.S. Provisional App. No. 63/539,909 filed on Sep. 22, 2023, incorporated herein by reference in its entirety.

### BACKGROUND

### Technical Field

The present invention relates to data prediction with artificial intelligence (AI), and more particularly to time-series data forecasting via multi-modal augmentation and fusion.

### Description of the Related Art

Artificial intelligence has progressed remarkably in predicting future events. For example, future reliability of a power distribution system for a given location can be predicted using predictor models. However, the accuracy and performance of the predictor model is directly proportional to the amount of reliable training data used. Thus, a predictor model trained with insufficient training data is expected to be inaccurate.

### SUMMARY

According to an aspect of the present invention, a computer-implemented method for time-series forecasting via multi-modal augmentation and fusion is provided including decomposing time-series data and modality data into seasonal and trend representations with trend-seasonal decomposition, concatenating, using an encoder transformer model, time-series data embeddings and modality data embeddings from the seasonal representations and the trend representations to obtain crossed representations, processing, using the encoder transformer model, the modality data embeddings and the time-series data embeddings separately to obtain singular representations, augmenting the crossed representations and the singular representations through joint trend-seasonal decomposition to obtain augmented seasonal data and augmented trend data, fusing, using a decoder, augmented seasonal data and augmented trend data to obtain fused augmented data, and performing corrective action to correct predicted future events using a system with a prediction model trained with the fused augmented data.

According to another aspect of the present invention, a system for time-series forecasting via multi-modal augmentation and fusion is provided, including a memory device, and one or more processor devices operatively coupled with the memory device to decompose time-series data and modality data into seasonal and trend representations with trend-seasonal decomposition, concatenate, using an encoder transformer model, time-series data embeddings and modality data embeddings from the seasonal representations and the trend representations to obtain crossed representations, process, using the encoder transformer model, the modality data embeddings and the time-series data embeddings separately to obtain singular representations, augment the crossed representations and the singular representations through joint trend-seasonal decomposition to obtain augmented seasonal data and augmented trend data, fuse, using a decoder, augmented seasonal data and augmented trend data to obtain fused augmented data, and perform corrective action to correct predicted future events using a system with a prediction model trained with the fused augmented data.

According to another aspect of the present invention, a non-transitory computer program product comprising a computer-readable storage medium including program code for time-series forecasting via multi-modal augmentation and fusion is provided, wherein the program code when executed on a computer causes the computer to decompose time-series data and modality data into seasonal and trend representations with trend-seasonal decomposition, concatenate, using an encoder transformer model, time-series data embeddings and modality data embeddings from the seasonal representations and the trend representations to obtain crossed representations, process, using the encoder transformer model, the modality data embeddings and the time-series data embeddings separately to obtain singular representations, augment the crossed representations and the singular representations through joint trend-seasonal decomposition to obtain augmented seasonal data and augmented trend data, fuse, using a decoder, augmented seasonal data and augmented trend data to obtain fused augmented data, and perform corrective action to correct predicted future events using a system with a prediction model trained with the fused augmented data.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for time-series data forecasting via multi-modal augmentation and fusion, in accordance with an embodiment of the present invention;

FIG. 2 is a block diagram illustrating a computing system for time-series data forecasting via multi-modal augmentation and fusion in accordance with an embodiment of the present invention;

FIG. 3 is a block diagram showing a computer software implementation of time-series data forecasting via multi-modal augmentation and fusion, in accordance with an embodiment of the present invention;

FIG. 4 is a block diagram illustrating a practical application of time-series data forecasting via multi-modal augmentation and fusion, in accordance with an embodiment of the present invention; and

FIG. 5 is a block diagram illustrating deep learning neural networks for time-series data forecasting via multi-modal augmentation and fusion, in accordance with an embodiment of the present invention.

### DETAILED DESCRIPTION OF PREFERRED EMBODIMENTS

In accordance with embodiments of the present invention, systems and methods are provided for time-series data forecasting via multi-modal augmentation and fusion.

Time-series data forecasting can arise in various real-world complex systems including weather, healthcare, energy, etc. Accurate time-series data forecasting provides efficient system maintenance, resource allocation, risk reduction, and better decision-making. For example, accurate forecasting of future energy consumption of a given location is important to efficiently allocate resources of a power utility entity and provide stable energy supply to the given location.

In an embodiment, the present embodiments can improve artificial intelligence models for time-series forecasting by employing a prediction model trained with fused augmented data that can be used to perform corrective action to correct predicted future events, such as system failures, using a system with the trained prediction model. The fused augmented data can be obtained by fusing, using a decoder, singular representations and crossed representations by integrating shared tokens. The fused augmented data have coherent alignment between the time-series data and the modality data. Singular representations can be obtained by processing, using the encoder transformer model, modality data and time-series data separately to augment the input dataset. Singular representations can refer to data embeddings that avoid interactions between patches across different modalities. Crossed representations can be obtained by concatenating, using an encoder transformer model, time-series data and modality data to enhance the quality of an input dataset. Crossed representations can refer to data embeddings having joint interactions across patches from different modality data. Time-series data and modality data can be decomposed into seasonal and trend data.

The present embodiments improve prediction performance of prediction models through multi-modal data augmentation. Multi-modal data augmentation can include horizontal and vertical augmentations, enriching the training data from distinct perspectives. In the horizontal augmentation, time-series and modality data can be concatenated and applying them jointly to the encoder. On the other hand, vertical augmentation leverages modality data to increase the number of training samples. Thus, the present embodiments improve prediction performance by augmenting training samples.

The present embodiments improve the accuracy of prediction models through the integration of shared tokens used to fuse the multiple modalities. By allowing time-series and modality data to be constructed from a set of learnable shared tokens, the present embodiments can achieve a coherent alignment of their different granularities which enhances the interplay between these modalities. Furthermore, the shared tokens enable the present embodiments to interpret the significance of individual components within each modality. Thus, the present embodiments gain a significant prediction accuracy improvement over other prediction methods.

In many scenarios, time-series data can be accompanied by modality information. For example, a monitored system can collect time-series data and modality data regarding the performance of the monitored system. However, methods that use single modality datasets with data augmentation can become inaccurate with insufficient data.

The present embodiments improve prediction models as the present embodiments can predict future events with insufficient time-series data (e.g., data scarcity) while maintaining accuracy and performance through multi-modal augmentation and fusion that captures the relevance between multiple modalities.

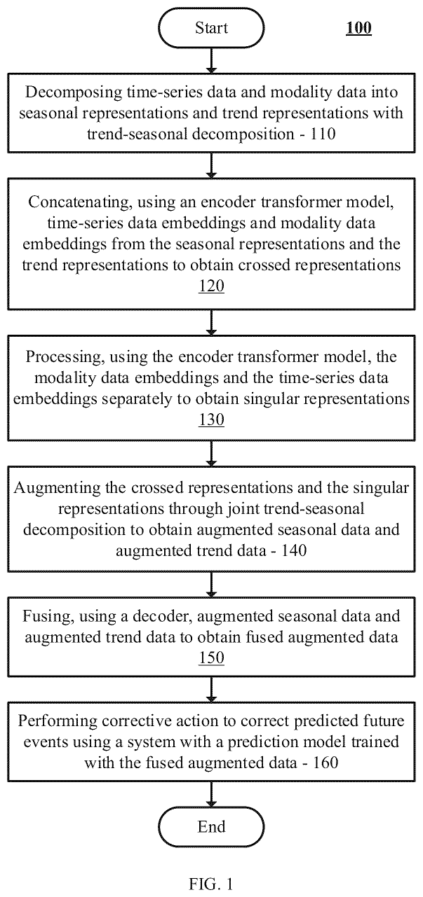

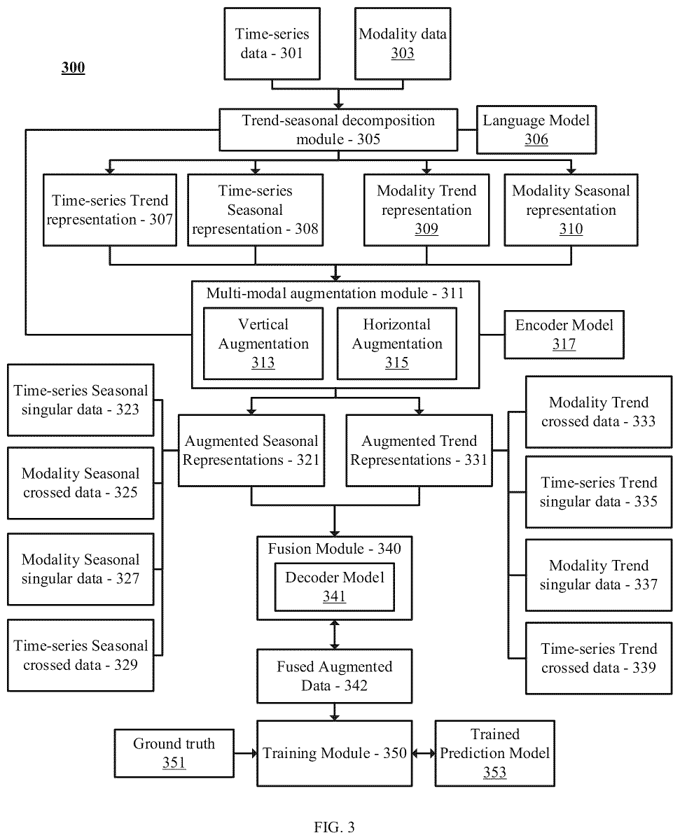

Referring now in detail to the figures in which like numerals represent the same or similar elements and initially to FIG. 1, a high-level overview of a computer-implemented method for time-series data forecasting via multi-modal augmentation and fusion is illustratively depicted in accordance with one embodiment of the present invention. Note that the reference numbers for the features described in FIG. 1 are further described in FIG. 3.

In an embodiment, the present embodiments improve accuracy and performance of prediction models via multi-modal augmentation and fusion. Time-series data 301 and modality data 303 can be collected as inputs. The time-series data 301 and modality data 301 can be decomposed into their respective seasonal (e.g., time-series seasonal representation 308, modality seasonal representation 310) and trend data representation (e.g., time-series trend representation 307, modality trend representation 309) components. These decomposed components then undergo multi-modal augmentation by employing a shared encoder 317. During multi-modal augmentation, time-series data 301 and modality data 303 can be concatenated to enhance the quality of an input dataset and obtain crossed representations. Additionally, during multi-modal augmentation, modality data and time-series data can be processed separately to augment the input dataset and obtain singular representations. Furthermore, during multi-modal augmentation, the crossed representations and the single modality representations can be augmented to obtain augmented seasonal data 321 and augmented trend data 331.

After multi-modal augmentation, the augmented seasonal data and the augmented trend data can be fused by integrating shared tokens to obtain fused augmented data 342 with coherent alignment between the time-series data 301 and the modality data 303. The fused augmented data 342 can then be individually passed to a decoder 341 which approximates these combined outputs to the ground-truth time-series data 351 (shown in FIG. 3). A prediction model 353 can be trained with the fused augmented data 342 which can be employed to predict future events and perform a corrective action in accordance to the predicted future events.

In block 110, collected time-series data and modality data can be decomposed into seasonal and trend data.

In an embodiment, collected time-series data 301 and modality data 303 can be decomposed through time-series decomposition. Time-series data 301 can refer to a series of data collected at regular intervals. For example, in power utility systems, the performance of the power lines can be collected at regular intervals (e.g., seconds, minutes). Modality data 303 can refer to different types of data that are relevant to the time-series data. Modality data 303 can be text data, audio data, image data. For example, in the example above, the modality data 303 can be reports, audio recordings, or a graph image showing that the performance of a system component of a monitored system is down by five percent.

Trend-seasonal decomposition can refer to the decomposition of time-series data 301 (or modality data 303) into two types of representations: trend representations and seasonal representations. The trend representations can refer to smoothed time-series data that can be achieved through a moving average of the original data. The seasonal representations can refer to the deviation between the original data and the trend representation.

To obtain trend representations, the collected time-series data can undergo patch-wise embedding. The time-series data 301 can be segmented into multiple non-overlapping patches for a patch length P, which can be mapped into a d-dimensional latent space using a learnable linear projection. The d-dimensional latent space can be learned by a frozen pretrained language model. The frozen pretrained language model can be a Transformer model. To obtain seasonal representations, the modality data 303 can be segmented into multiple patches d, with each patch spanning a duration of P timesteps. The modality information contained within a patch d can be aggregated into a single embedding vector. Attentive pooling, through the frozen pretrained language model, can be employed to account for potential differences in modality significance across different channels.

The seasonal representations can be mapped into a d-dimensional latent space using a trainable linear projection that can temporarily align with the trend representations.

The seasonal representations and the trend representations can then undergo multi-modal augmented encoding which can have at least two augmentation processes: vertical augmentation which is further described in block 130 and horizontal augmentation which is further described in block 120.

In block 120, time-series data embeddings and modality data embeddings from the seasonal representations and the trend representations can be concatenated to enhance the quality of an input dataset and obtain crossed representations.

In an embodiment, time-series data embeddings and modality data embeddings can be concatenated to enhance the quality of an input dataset (e.g., horizontal augmentation) and obtain crossed representations (e.g., 325, 329, 333, 339). Crossed representations can refer to data embeddings having joint interactions across patches from different modality data. To obtain crossed representations, the time-series data embeddings (obtained through patch-wise embedding) and the modality data embedding (obtained through patch-wise embedding) can be split based on the modality which can be concatenated and passed into an encoder model to allow joint interactions across patches from different modality data. The encoder model 317 can be a Transformer model.

In block 130, the modality-data embeddings and the time-series data embeddings can be processed separately to obtain singular representations.

In an embodiment, the modality-data embeddings and the time-series data embeddings can be processed separately (e.g., vertical augmentation) to obtain singular representations (e.g., 323, 327, 335, 337). Singular representations can refer to embeddings that avoid interactions between patches across different modalities. To obtain singular representations, the modality-data embeddings and the time-series data embeddings, which were obtained from patch-wise embeddings, can be fed into an encoder model 317 separately. The encoder model 317 can be a Transformer model.

Both vertical and horizontal augmentation enhances the generalization of the encoder model, thus improving the accuracy and performance of a prediction model 353. The crossed representations and the singular representations can be further augmented by refining the crossed representations and the singular representations through joint trend-seasonal decomposition.

In block 140, the crossed representations and the singular representations can be augmented through joint trend-seasonal decomposition to obtain augmented seasonal data and augmented trend data.

In an embodiment, the crossed representations and the singular representations can be augmented through joint trend-seasonal decomposition to obtain augmented seasonal representations 321 and augmented trend representations 331. To obtain augmented seasonal representations 321 and augmented trend representations 331, both crossed representations and singular representations can undergo trend-seasonal decomposition through an encoder model as described herein.

Performing trend-seasonal decomposition on the crossed representations can generate crossed trend representations and crossed seasonal representations. Performing trend-seasonal decomposition on the singular representations can generate singular trend representations (e.g., 335, 337) and singular seasonal representations (e.g., 323, 327). Performing trend-seasonal decomposition on the crossed representations can generate crossed trend representations (e.g., 333, 339) and crossed seasonal representations (e.g., 325, 329). During trend-seasonal decomposition, the crossed representations and the singular representations can then be split into their time-series and modality data embeddings which can generate at least sixteen representations which are the different combinations of the time-series, modality, crossed, singular, trend and seasonal representations.

To perform trend-seasonal decomposition on the time-series data of the crossed and singular representations, the trend data and seasonal data can be split and patch embeddings from the trend and seasonal data can be computed. To perform trend-seasonal decomposition on the modality data of the crossed and singular representations, a separate attention parameter can be used for the trend and seasonal data, respectively, to compute the embeddings of the patches corresponding to the trend and seasonal data. The patch embeddings of the time-series data previously obtained can then be used as query vectors in the attention mechanism which can yield specialized embeddings that capture the dynamics of trend and seasonal patterns within the modality data. The augmented seasonal representations 321 and augmented trend representations 331 can then be fused to train a prediction model.

In block 150, the augmented seasonal and the augmented trend data can be fused using a decoder to obtain fused augmented data.

In an embodiment, the augmented seasonal representations 321 and the augmented trend representations 331 can be fused using a decoder to obtain fused augmented data. To fuse augmented seasonal representations 321 and the augmented trend representations 331, the possible combinations of the decomposed representations can be aggregated through single-layer linear decoders for the trend and seasonal representations. The loss for each prediction using its corresponding data (e.g., prediction of a time single modality seasonal representation) can be computed individually which can cumulatively contribute to a combined loss function. A prediction model 353 can then be trained using the combined loss function by learning the weights associated with each prediction using their corresponding data. The prediction model 353 can be a Transformer model, or other deep learning neural networks such as convolutional neural networks or recurrent neural networks.

By fusing the decomposed representations, information from distinct modalities that offer complementary insights can be captured, thus improving the accuracy and performance of the prediction model. After training the prediction model with multi-modal augmentation and fusion, the prediction model can be used to predict future events.

In block 160, corrective action can be performed to prevent predicted future events using a system with a prediction model trained with the fused augmented data.

In an embodiment, corrective action, such as updating configuration of a monitored system, can be performed to prevent predicted future event of system failure.

In another embodiment, in a healthcare setting, corrective action such as updating public health safety procedures, can be performed for a monitored public health system to correct and prevent spread of an infectious disease within a community. Additionally, corrective action such as updating medical treatment of a patient can be performed to prevent progression of a disease.

The present embodiments improve prediction models as the present embodiments can predict future events with insufficient time-series data (e.g., data scarcity) while maintaining accuracy and performance through multi-modal augmentation and fusion.

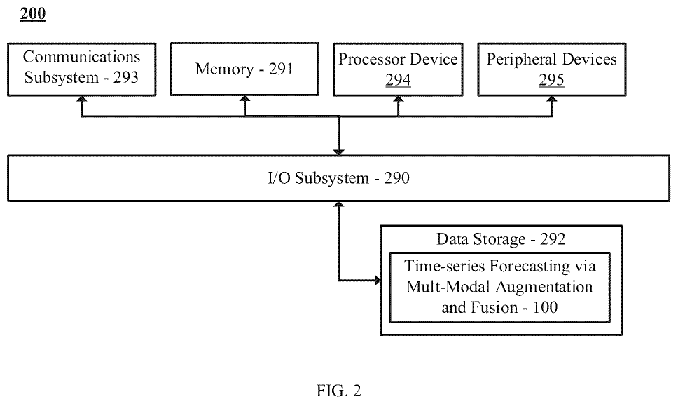

Referring now to FIG. 2, a block diagram showing a computing system for time-series data forecasting via multi-modal augmentation and fusion 200, in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code for time-series forecasting via multi-modal augmentation and fusion 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Referring now to FIG. 3, a block diagram showing a computer software implementation of time-series data forecasting via multi-modal augmentation and fusion, in accordance with an embodiment of the present invention.

In an embodiment, a software implementation 300 can include a trained prediction model 353 that can be trained by a training module 350 using a fused augmented data 342 and ground truth 351. The fused augmented data 342 can be obtained by a fusion module 340 that can employ a decoder model 341 to fuse augmented seasonal representations 321 and augmented trend representations 331.

The augmented seasonal representations 321 can include time-series seasonal singular data 323, modality seasonal crossed data 325, modality seasonal singular data 327, and time series seasonal crossed data 329. The augmented trend representations 331 can include time-series trend singular data 335, modality trend crossed data 333, modality trend singular data 337, and time series trend crossed data 339. The singular data representations including time-series seasonal singular data 323, modality trend singular data 337, time-series trend singular data 335, and modality seasonal singular data 327 can be obtained by vertical augmentation 313 through a multi-modal augmentation module 311 that can employ encoder model 317. The crossed data representations including time-series seasonal crossed data 329, modality trend crossed data 333, time-series trend crossed data 339, and modality seasonal crossed data 325 can be obtained by horizontal augmentation 315 through a multi-modal augmentation module 311 that can employ encoder model 317.

The augmented seasonal representations 321 and augmented trend representations 331 are obtained through the multi-modal augmentation module 311 by processing time-series trend representation 307, time-series seasonal representation 308, modality trend representation 309, and modality seasonal representation 310. The time-series trend representation 307, time-series seasonal representation 308, modality trend representation 309, and modality seasonal representation 310 can be decomposed using a trend-seasonal decomposition module 305, that can employ a trained language model 306, from collected time-series data 301 and modality data 303.

In an embodiment, the trained prediction model 353 can be employed by a maintenance system for a monitored system. In another embodiment, the trained prediction model 353 can be employed by an artificial intelligence (AI) assistant to assist the decision-making process of a decision-making entity.

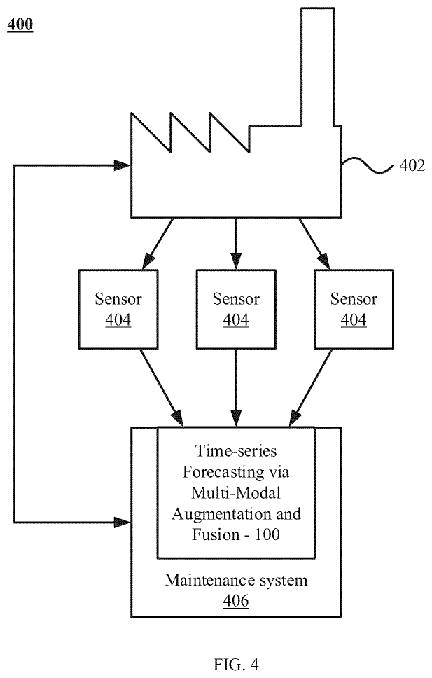

Referring now to FIG. 4, a block diagram illustrating a practical application of time-series data forecasting via multi-modal augmentation and fusion, in accordance with an embodiment of the present invention.

In an embodiment, a system 400 can include a maintenance system 406 in the context of a monitored system 402 is shown. The monitored system 402 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems may include a wide range of different types, including railroad systems, power plants, vehicle sensors, data centers, satellites, and transportation systems. Another type of cyber-physical system can be a network of internet of things (IoT) devices, which may include a wide variety of different types of devices, with various respective functions and sensor types. The monitored system 402 can employ a maintenance system 406 that includes a trained prediction model 353 with time-series forecasting via multi-modal augmentation and fusion 100 and sensors that collect time-series data, and modality data from the monitored system.

One or more sensors 404 record information about the state of the monitored system 402. The sensors 404 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The sensor data may include, e.g., numerical data and categorical or binary-valued data. The information generated by the sensors 404 can be in any appropriate format and can include sensor log information generated with heterogeneous formats.

The sensors 404 may transmit the logged sensor information to a maintenance system 406 by any appropriate communications medium and protocol, including wireless and wired communications. The maintenance system 406 can, for example, predict abnormal or anomalous behavior by monitoring the multivariate time series that are generated by the sensors 404. Once anomalous behavior has been predicted, the maintenance system 406 communicates with a system control unit to alter one or more parameters of the monitored system 402 to prevent and correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 406 thereby automatically corrects or mitigates the anomalous behavior. By identifying the particular sensors 404 that are associated with the anomalous classification, the amount of time needed to isolate a problem can be decreased.

Each of the sensors 404 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering a hundred measurements. The sensors 404 can also output a modality data collected from the monitored system 402 such as audio recordings, text, or images of system components.

The maintenance system 406 therefore includes a model that is trained to handle numerical and categorical data. The model may be based on patch embeddings, where a time series may be partitioned into multiple sets of non-overlapping patch embeddings may be built for each categorical value. The distribution of patch embeddings may then be used to determine a normal range and threshold for these values, to aid in predicting and identifying anomalies.

For a complicated system 406, the number of sensors may be very large, with the sensors reporting independent streams of time-series data. Predicting the cause of an anomaly in such a system can be challenging. A model may be trained to predict and detect anomalies in an explainable way, reporting not only an anomaly's time period, type, and value details, but also provide explanations on why the anomaly is abnormal and how normal data would compare. To explain the results of an anomaly prediction, anomaly profiles may be stored to predict and identify the cause of the anomaly. Expected values may be provided as a normal baseline for comparison.

In another embodiment, a forecast of the energy consumption of a community can be predicted using a trained prediction model that is trained using time-series data of the household energy consumption and modality data relevant to the energy consumption of the community such as newspaper articles, utility worker audio recordings, and images. The forecast of the energy consumption can then be used by an energy department entity to generate an energy consumption plan and increase energy output for the community to address energy deficiencies within the community.

In another embodiment, in a healthcare setting, the level of severity of a disease of a person can be predicted using time-series healthcare data of the patient such as vital signs. Modality healthcare data such as healthcare summary data, healthcare professional audio recordings, or X-ray images can be sent to a network and used to train a prediction model with time-series data multi-modal augmentation and fusion 100 to obtain a trained prediction model. The trained prediction model can then be employed by a health forecaster, an artificial intelligence assistant, to generate a forecasted severity of illness of the patient. The forecasted severity of illness of the patient can then be used by a healthcare professional to assist in the decision-making process to create a medical diagnosis for the patient. By predicting the level of severity of the patient's disease, a timely medical diagnosis and an updated medical treatment for the patient can be predicted and performed which can lead to a better patient outcome.

In another embodiment, proliferation of an infectious disease within a community can be predicted using time-series healthcare data of confirmed cases, fatalities, and recoveries collected from different locations. In addition to collected time-series healthcare data, modality data regarding the infectious disease such as news articles, recordings or images can be used to train a prediction model with multi-modal augmentation and fusion. By predicting the proliferation of the infectious disease, a level of severity of the infectious disease can be determined by a public health entity. The level of severity can dictate the corrective action that the public health entity can take to prevent the heightened level of severity of the infection disease.

Other practical applications are contemplated.

The present embodiments can employ a predictor model to predict future events using time-series data and modality data via multi-modal augmentation and fusion. The predictor model can be a deep learning neural network.

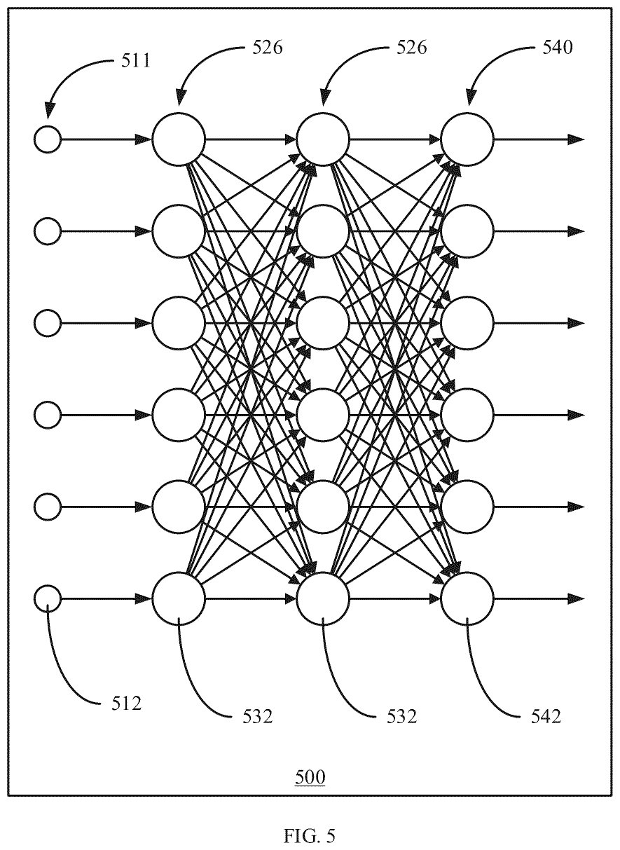

Referring now to FIG. 5, a block diagram illustrating deep learning neural networks for time-series data forecasting via multi-modal augmentation and fusion, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the trained prediction model 353 can learn relationships between the fused augmented data 342 and ground truth 351. The output layer 540 of the trained prediction model 353 can then provide the overall response of the network as a likelihood score of a prediction of a future event based on the fused augmented data 342 and the ground truth 351. In another embodiment, the encoder model 317 can learn linear projections to map patch embeddings to a d-dimensional latent space to perform trend-seasonal decomposition. In another embodiment, the decoder model 341 can learn the shared tokens between the augmented seasonal representations 321 and the augmented trend representations 331 to fuse both representations and obtain fused augmented data 342.

Training a deep neural network can involve two phases, a forward phase where the weights of each neuron are fixed and the input propagates through the network, and a backwards phase where an error value is propagated backwards through the network and weight values are updated.

The computation neurons 532 in the one or more computation (hidden) layer(s) 526 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for time-series forecasting via multi-modal augmentation and fusion, comprising:
decomposing time-series data and modality data into seasonal representations and trend representations with trend-seasonal decomposition;
concatenating, using an encoder transformer model, time-series data embeddings and modality data embeddings from the seasonal representations and the trend representations to obtain crossed representations;
processing, using the encoder transformer model, the modality data embeddings and the time-series data embeddings separately to obtain singular representations;
augmenting the crossed representations and the singular representations through joint trend-seasonal decomposition to obtain augmented seasonal data and augmented trend data;
fusing, using a decoder, augmented seasonal data and augmented trend data to obtain fused augmented data; and
performing corrective action to correct predicted future events using a system with a prediction model trained with the fused augmented data.

2. The computer-implemented method of claim 1, wherein performing corrective action further comprises updating an operational parameter of a hardware component of a monitored system to prevent a predicted system failure.

3. The computer-implemented method of claim 1, wherein performing corrective action further comprises updating medical diagnosis for a monitored patient to correct and prevent progression of a disease.

4. The computer-implemented method of claim 1, wherein decomposing time-series data and modality data further comprises learning patch embeddings, using a language model, to map the patch embeddings into a d-dimensional latent space.

5. The computer-implemented method of claim 1, wherein concatenating, using an encoder transformer model, time-series data and text data further comprises splitting concatenated embeddings from time-series data and text data to allow crossed interactions.

6. The computer-implemented method of claim 1, wherein augmenting the crossed representations and the singular representations further comprises computing attention parameters for the modality data of the crossed representations and the singular representations by using patch embeddings of the time-series data as query vectors in an attention mechanism.

7. The computer-implemented method of claim 1, wherein fusing, using a decoder, the singular representations and the crossed representations further comprises aggregating the augmented seasonal data and augmented trend data to contribute to a loss function for training a prediction model.

8. A system for time-series forecasting via multi-modal augmentation and fusion, comprising:
a memory device; and
one or more processor devices operatively coupled with the memory device to:
decompose time-series data and modality data into seasonal and trend representations with trend-seasonal decomposition;
concatenate, using an encoder transformer model, time-series data embeddings and modality data embeddings from the seasonal representations and the trend representations to obtain crossed representations;
process, using the encoder transformer model, the modality data embeddings and the time-series data embeddings separately to obtain singular representations;
augment the crossed representations and the singular representations through joint trend-seasonal decomposition to obtain augmented seasonal data and augmented trend data;
fuse, using a decoder, augmented seasonal data and augmented trend data to obtain fused augmented data; and
perform corrective action to correct predicted future events using a system with a prediction model trained with the fused augmented data.

9. The system of claim 8, wherein one or more processor devices operatively coupled with the memory device to perform corrective action further comprises updating an operational parameter of a hardware component of a monitored system to prevent a predicted system failure.

10. The system of claim 8, wherein one or more processor devices operatively coupled with the memory device perform corrective action further comprises performing corrective action further comprises updating medical diagnosis for a monitored patient to correct and prevent progression of a disease.

11. The system of claim 8, wherein one or more processor devices operatively coupled with the memory device to decompose time-series data and modality data further comprises learning patch embeddings, using a language model, to map the patch embeddings into a d-dimensional latent space.

12. The system of claim 8, wherein one or more processor devices operatively coupled with the memory device to concatenate, using an encoder transformer model, time-series data and text data further comprises splitting concatenated embeddings from time-series data and text data to allow crossed interactions.

13. The system of claim 8, wherein one or more processor devices operatively coupled with the memory device to augment the crossed representations and the singular representations further comprises computing attention parameters for the modality data of the crossed representations and the singular representations by using patch embeddings of the time-series data as query vectors in an attention mechanism.

14. The system of claim 8, wherein one or more processor devices operatively coupled with the memory device to fuse, using a decoder, the singular representations and the crossed representations further comprises aggregating the augmented seasonal data and augmented trend data to contribute to a loss function for training a prediction model.

15. A non-transitory computer program product comprising a computer-readable storage medium including program code for time-series forecasting via multi-modal augmentation and fusion, wherein the program code when executed on a computer causes the computer to:
decompose time-series data and modality data into seasonal and trend representations with trend-seasonal decomposition;
concatenate, using an encoder transformer model, time-series data embeddings and modality data embeddings from the seasonal representations and the trend representations to obtain crossed representations;
process, using the encoder transformer model, the modality data embeddings and the time-series data embeddings separately to obtain singular representations;
augment the crossed representations and the singular representations through joint trend-seasonal decomposition to obtain augmented seasonal data and augmented trend data;
fuse, using a decoder, augmented seasonal data and augmented trend data to obtain fused augmented data; and
perform corrective action to correct predicted future events using a system with a prediction model trained with the fused augmented data.

16. The non-transitory computer program product of claim 15, wherein to perform corrective action further comprises updating an operational parameter of a hardware component of a monitored system to prevent a predicted system failure.

17. The non-transitory computer program product of claim 15, wherein to decompose time-series data and modality data further comprises learning patch embeddings, using a language model, to map the patch embeddings into a d-dimensional latent space.

18. The non-transitory computer program product of claim 15, wherein to concatenate, using an encoder transformer model, time-series data and text data further comprises splitting concatenated embeddings from time-series data and text data to allow crossed interactions.

19. The non-transitory computer program product of claim 15, wherein to augment the crossed representations and the singular representations further comprises computing attention parameters for the modality data of the crossed representations and the singular representations by using patch embeddings of the time-series data as query vectors in an attention mechanism.

20. The non-transitory computer program product of claim 15, wherein to fuse, using a decoder, the singular representations and the crossed representations further comprises aggregating the augmented seasonal data and augmented trend data to contribute to a loss function for training a prediction model.
